(19) United States
(12) Patent Application Publication
(10) Pub. No.: US 2018/0257608 A1
(43) Pub. Date: Sep. 13, 2018

(54) COWLING FOR COWLED FLAT WINDSCREEN WIPER BLADE

(71) Applicant: Valeo Systèmes d'Essuyage, Le Mesnil Saint Denis (FR)

(72) Inventors: Stéphane Houssat, Issoire (FR); Eric Poton, Issoire (FR); Vincent Gaucher, Issoire (FR)

(73) Assignee: Valeo Systèmes d'Essuyage, Le Mesnil Saint Denis (FR)

(21) Appl. No.: 15/913,114

(22) Filed: Mar. 6, 2018

(30) Foreign Application Priority Data
Mar. 7, 2017 (FR) 1751814

(51) Int. Cl. B60S 1/04

(52) U.S. Cl. CPC B60S 1/0408

(57) ABSTRACT

Cowling for a cowled flat windscreen wiper blade, in particular for a vehicle, the cowling being elongate and having a central mounting (2) and two end covers (3), at least one of the covers (3) being provided with two longitudinal side walls (3a, 3b) that are linked by an upper longitudinal edge (3c), said mounting (2) being positioned between the two covers (3) and assembled with each cover (3), the cowling being characterized in that said mounting (2) has lateral retaining means (7) cooperating with the lateral retaining means (6a, 6b) of at least one of the two side walls (3a, 3b) in order to limit a lateral deformation of said at least one of the two side walls (3a, 3b).

### TECHNICAL DOMAIN

The present invention concerns a cowling for a cowled flat windscreen wiper blade, in particular of a vehicle. The invention also concerns a cowled flat blade fitted with said cowling.

### PRIOR ART

Conventionally, a wiper blade of a glass such as a windscreen of a motor vehicle includes notably a wiper rubber, which is usually made of rubber, intended to rub against the glass of the vehicle to move the water out of the driver's field of vision. The blade is carried by an arm that is driven by a motor in an angular to-and-fro movement.

Notably, two types of windscreen wiper blade technology are known: whippletree blade technology, in which articulated yokes hold the wiper rubber at several distinct points, and flat-blade technology, in which a semi-rigid assembly holds the wiper rubber along the entire length thereof.

In both solutions, the blade is attached to the turning arm of the windscreen wiper by an assembly comprising a mechanical connector and an adapter. The connector is a part attached directly to the structure of the blade or directly to the flat blade, the adapter being an intermediate part that enables the connector to be attached to the windscreen wiper arm. These two parts are linked to one another by a transverse shaft that enables the relative rotation of said parts.

Whippletree blade technology is well known to the person skilled in the art. Application FR-A1-2681028 filed by the same applicant describes, for example, an asymmetrical whippletree windscreen wiper blade. A whippletree blade has the advantage of pressing a wiper rubber against the glass of the vehicle with a pressure that is relatively uniform over the entire length of the blade. However, this technology has drawbacks, such as the size thereof, for example.

Flat blade technology is also well known to the person skilled in the art. In this case, the blade is fitted with at least one longitudinal link that stiffens the wiper rubber to facilitate application of said wiper rubber to the glass of the vehicle. This link is curved and said curve enables the wiper rubber to be kept pressed against the glass, even at the longitudinal ends of the blade.

Fitting a cowling to a windscreen wiper blade, notably to optimize the aerodynamics thereof, has already been proposed. It is also known to fit a cowling to a whippletree blade. It is also known to improve a flat windscreen wiper blade by fitting a cowling thereto, thereby proposing a cowled flat windscreen wiper blade.

In the present application, flat blade shall mean a blade including notably a curving link. There are two main types of flat blades:

one type having two curving links seated in lateral slots of a wiper rubber included in the blade,

the other type having just one curving link seated in a seat of a holding device, said device also being designed to hold a wiper rubber using retaining grips.

Cowled flat blade shall mean a flat blade fitted with a cowling. Cowling shall mean an external part that is usually shaped.

The cowling is applied in three portions that are jointed with one another. The central portion, referred to as the central mounting, performs the functions of a connector of a flat blade with no cowling, i.e. the different elements extending along the length of the blade are attached to this central part. Two portions, referred to as end covers, are attached to this central mounting in eccentric longitudinal positions. The end covers are typically assembled with the central mounting by means of a pivoting link.

The present invention proposes a cowling that can be adapted to fit a flat blade or a whippletree blade, in which the assembly between the central mounting and the end covers is difficult to disassemble.

### DESCRIPTION OF THE INVENTION

The invention therefore relates to a cowling for a windscreen wiper blade extending along a longitudinal axis, in particular for a vehicle, the cowling being elongate and having a central mounting and two end covers, at least one of the covers being provided with two longitudinal side walls that are linked by an upper longitudinal edge, said mounting being positioned between the two covers and assembled with each cover.

In the cowling according to the invention, said mounting comprises lateral retaining means cooperating with the lateral retaining means of at least one of the two side walls in order to limit a lateral deformation of said at least one of the two side walls.

Thus, advantageously, the lateral retaining means make it possible to limit the deformation of said at least one of the two side walls. This makes it very difficult to separate the two side walls to access the assembly zone of the cover and the mounting, which makes it difficult to disassemble the cowling. The assembly between said at least one of the covers and the mounting is typically located in the space between the two side walls.

The mounting preferably comprises lateral retaining means cooperating with the lateral retaining means of the two side walls.

The lateral retaining means of the mounting and/or of said at least one of the two side walls preferably extend longitudinally.

The lateral retaining means of the mounting may comprise a longitudinal rib and the lateral retaining means of said at least one of the two side walls may comprise a longitudinal slot formed in a projecting zone of said at least one of the two side walls.

Alternatively, the lateral retaining means of the mounting may comprise a longitudinal slot and the lateral retaining means of said at least one of the two side walls can have a longitudinal rib projecting from said at least one of the two side walls.

The assembly between the mounting and said at least one of the covers may be a fastening or a joint.

The assembly between the mounting and said at least one of the covers may be a joint and said at least one of the covers can have an articulation element provided with articulation means.

The joint may be a pivoting link and the articulation means may be rotation means. In this case, the articulation means can define an axis of rotation orthogonal to the longitudinal axis of the cowling.

The articulation means may have two half-shafts arranged on either side of a central wall of said articulation element.

Said at least one of the covers may comprise rigid attachment means that are designed to cooperate with the rigid attachment means of the mounting to rigidly attach said at least one of the covers to said mounting.

The rigid attachment means of said at least one of the covers and the rigid attachment means of the mounting may be snap-fitting means.

The rigid attachment means of said at least one of the covers may be carried on the articulation element and notably on the articulation means.

The lateral retaining means of said at least one of the two side walls may include a frangible zone, to prevent the cowling from being reassembled.

The invention also relates to a cowled flat windscreen wiper blade including the cowling described above.

The invention also relates to a cowled whippletree windscreen wiper blade including the cowling described above.

### DESCRIPTION OF THE FIGURES

The invention can be better understood from, and other details, characteristics and advantages of the invention are set out in, the description below, given by way of non-limiting example and with reference to the attached drawings, in which:

FIG. 1 is a schematic perspective view of a cowled flat windscreen wiper blade in a free unstressed state.

FIG. 2 is a schematic perspective view of the blade in FIG. 1 bearing against a glass, in particular of a vehicle,

FIG. 3 is an exploded perspective detailed view of a portion of a cowled flat blade,

FIG. 4 is a schematic cross section of an end cover of a cowling for a cowled flat windscreen wiper blade according to the prior art,

FIG. 5 is a schematic cross section of a cowling for a cowled flat windscreen wiper blade according to the invention,

FIG. 6 is a partial perspective top view of a central mounting of a cowling for a cowled flat windscreen wiper blade according to the invention, and

FIG. 7 is a partial perspective top view of a cover of a cowling for a cowled flat windscreen wiper blade according to the invention.

### DETAILED DESCRIPTION

It should be noted that the figures show the invention in detail to enable the invention to be carried out, and these figures may be understood to better define the invention where appropriate.

In the description below, the terms “longitudinal” and “lateral” relate to the orientation of the wiper blade according to the invention. The longitudinal direction corresponds to the main axis of the blade along which it extends, while the lateral orientations correspond to the convergent straight lines, i.e. lines crossing the longitudinal direction, notably perpendicular to the longitudinal axis of the blade in the plane of rotation of same. For the longitudinal directions, the terms “outside” or “inside” shall be understood in relation to the fastening point of the blade on a blade-carrying arm, the term “inside” corresponding to the portion in which the arm and one half-blade extend. Finally, the directions referred to as “upper” and “lower” correspond to orientations perpendicular to the plane of rotation of the windscreen wiper blade, the term “lower” containing the plane of the windscreen.

Where applicable, the term “inner” or “internal” can refer to the inside of a part or to an inner/internal side of a part, as opposed to the outside of a part (which makes it possible to qualify the visible or external aspects of the part, for example) or to the outer/external side of the part.

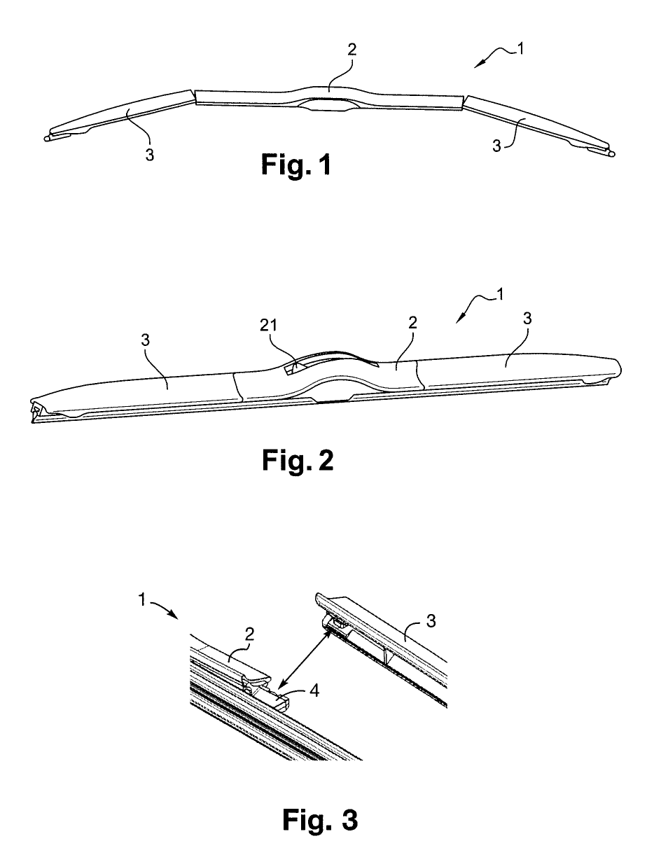

In FIGS. 1 to 7, identical elements or elements having equivalent functionality are indicated using identical reference numbers.

FIG. 1 shows a cowled flat blade 1 according to the invention, i.e. a flat blade fitted with a cowling, the cowled flat blade 1 being in a free position in space, under no stress.

The upper portion of the blade 1 is formed by the cowling, which has an aerodynamic shape that deflects the air hitting the windscreen upwards. The cowling thus forms an aerodynamic deflector. The aforementioned deviation of air generates a bearing force of the blade 1 on the windscreen that ensures a continuous contact on the windscreen, in combination with a second bearing force generated by a pressure of the arm, and therefore a reliable wipe.

The shape of this cowling is substantially a dihedral formed by two longitudinal walls that join at the top at an apex edge, the front wall having a hollow aerodynamic shape, while the rear wall is substantially flat in the example shown. The inside of the dihedral is hollow to leave space to seat the elements that form a wiping unit of a flat blade. Such a wiping unit notably has a curving link seated in a seat of a holding device, said device also being designed to hold a wiper rubber using retaining grips.

The cowling is applied in three portions that are jointed with one another. The central portion, hereinafter referred to as the central mounting 2, performs the functions of a connector of a flat blade with no cowling, i.e. the different elements extending along the length of the blade 1 are attached to this central part. With the exception of the centre of the central mounting, which has substantially parallel vertical walls designed to receive therebetween an adapter designed to enable the link with the blade-carrying arm, this central mounting 2 has the aerodynamic deflector cowling shape described above. The central mounting therefore has two longitudinal side walls in which the upper longitudinal edges are linked together such that said walls substantially form a dihedral. Two portions, hereinafter referred to as end covers 3, are attached to this central mounting 2 in eccentric longitudinal positions. These two covers 3 also have the aerodynamic deflector cowling shape along the entire length thereof. Each cover 3 therefore has two longitudinal side walls 3a, 3b in which the upper longitudinal edges are linked together such that said walls substantially form a dihedral. The upper longitudinal edges of the walls 3a, 3b are linked together to form an upper longitudinal edge 3c of the cover 3.

A first end cover 3 extends inwards, while the second extends outwards. The link between the central mounting 2 and each of the end covers 3 is typically a joint that pivots about an axis oriented in a lateral or transverse direction, such that the two end covers 3 move in a plane perpendicular to the plane of rotation of the blade. The break thus created between the central mounting 2 and the end covers 3 prevents the inner and outer ends of the blade being pressed against the windscreen by a pressure lower than the pressure exerted at the central mounting, on account of a greater distance from the support point thereof in relation to the drive arm of the blade.

The central portion of the central mounting 2 is taller than the rest of the blade on account of the connector role thereof, which enables same to receive the attachment means of the blade to the drive arm, and in particular an adapter.

FIG. 2 shows the same blade 1 in a position bearing against a glass, shown here for the sake of simplicity as a flat surface. The joints between the central mounting 2 and the two end covers 3 are closed, i.e. these covers are positioned on the axis of the central mounting, the upper surfaces of these three parts forming a continuous cowling surface. The central portion of the central mounting 2 has a window 21 that is traversed by the end of a drive arm and has a transverse shaft onto which the adapter (not shown) is attached, connecting the blade to the arm.

As shown in FIG. 3, the central mounting 2 of a cowled flat blade 1 comprises, longitudinally and on either side, two articulation or linking means that have fingers 4 that extend longitudinally from the body of the mounting 2. These fingers 4 have a seat that extends longitudinally and is designed to receive an articulation shaft carried on the corresponding end cover 3. The cooperation between this articulation shaft and the seat in the finger 4, typically by snap-fitting, enables the rotation of the cover 3 in relation to the central mounting 2 in a plane perpendicular to the plane of rotation of the blade 1.

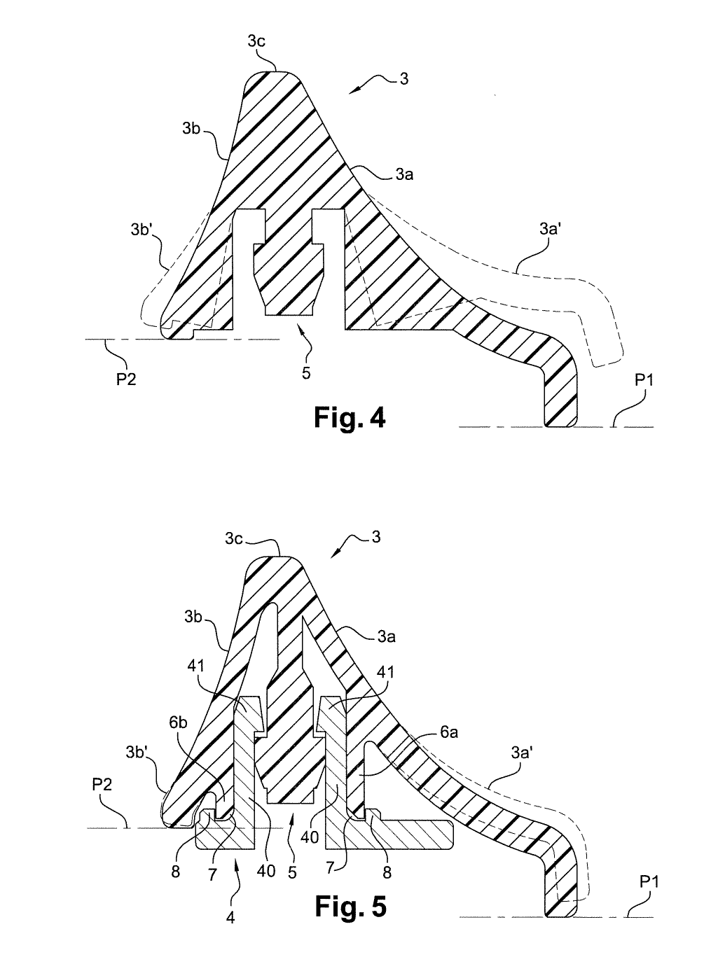

The articulation shaft is carried on an articulation element 5 of the cover 3, shown schematically in FIG. 4 and detailed in FIG. 7. The articulation element 5, which also acts as snap-fitting element with the mounting 2, is designed to be snap-fitted into the seat of the finger 4 of the mounting 2. The articulation element 5 is arranged between the two longitudinal side walls 3a, 3b and extends substantially through the longitudinal plane of the cover 3 orthogonal to the plane of rotation of the windscreen wiper blade, passing through the upper longitudinal edge 3c of the cover 3.

The asymmetrical nature of the aerodynamic deflector cowling shape of the cover 3 means that the lower longitudinal edges of the longitudinal side walls 3a, 3b of the mounting 2 are not located at the same height or vertical direction (the horizontal direction being substantially parallel to the windscreen, making the vertical direction substantially perpendicular to the windscreen), the lower edge of the wall 3a being located lower than the lower edge of the wall 3b. In other words, the lower edge of the wall 3a is located substantially in a first substantially horizontal longitudinal plane P1 that is removed from and, in this case, beneath a second substantially horizontal longitudinal plane P2 passing substantially through the lower edge of the wall 3b.

Such an arrangement makes it possible to separate the side walls 3a, 3b by deforming same laterally, notably towards the upper edge 3c, and in particular by deforming the side wall 3a, which enables access to the snap-fitting of the cover 3 to the mounting 2 in order to disassemble the cowling. The deformed position 3a′ of the side wall 3a is shown using a dotted line. Equally, the deformed position 3b′ of the side wall 3b is shown using a dotted line.

It is desirable to have a cowling in which these deformations are limited, such as to stiffen the cover where same is assembled with the mounting and to prevent access to the snap-fitting zone located between the side walls of the end cover.

The invention achieves this objective by providing the central mounting and at least one of the side walls 3a, 3b of the cover 3 with lateral retaining means that cooperate to limit or prevent a lateral deformation of at least one of the two side walls of the cover.

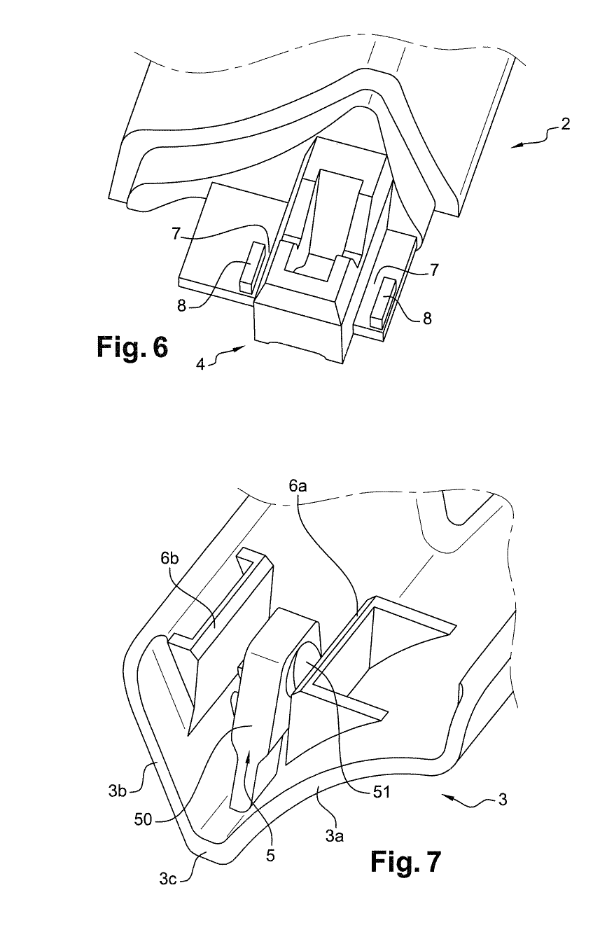

As shown in FIG. 5, a substantially vertical rib 6a, 6b (or flank) projects from each side wall 3a, 3b of the cover 3 and is seated in a horizontal longitudinal slot 7 of the finger 4 of the central mounting 2. Each rib 6a, 6b is arranged on an inner face of the side wall 3a, 3b bearing same. Each slot 7 is delimited at the centre by a vertical longitudinal wall 40 of the finger 4 and laterally by a longitudinal rib 8 of the finger 4. It is also possible to use just one rib 6a, 6b, preferably the rib 6a projecting from the side wall 3a having the lower edge in the lowest plane P1, since the lateral deformation is greatest on this side.

Thus, the side walls 3a, 3b of the cover 3 are held laterally opposite the mounting 2 since the ribs 6a, 6b projecting from the side walls 3a, 3b are blocked laterally in the slots 7.

Any attempt to separate the side walls 3a, 3b reveals that deformation of these walls 3a, 3b is limited. The deformed positions 3a′ and 3b′ of the side walls 3a and 3b are shown using dotted lines (FIG. 5). The limited separation of the walls 3a, 3b prevents access to the articulation zone between the articulation element 5 of the cover 3 and the finger 4 of the mounting 2, which prevents the cowling from being disassembled.

The mounting 2 and the cover 3 are designed to be rigidly connected by snap-fitting , for example in a longitudinal plane of the cover 3 orthogonal to the plane of rotation of the windscreen wiper blade and passing through the upper longitudinal edge 3c of the cover 3.

The elongate articulation part 5 includes articulation means in the form of two circular-section half-shafts 51 located on either side of a longitudinal plane of symmetry of the articulation element 5 and projecting from a central wall 50 of the articulation element 5 (FIG. 7). The half-shafts 51 form a transverse axis of rotation, each half-shaft 51 being designed to be received in an orifice oriented transversally in the finger 4 of the mounting 2. The cooperation between this articulation shaft formed by the half-shafts 51 and the orifices in the finger 4 enables the rotation of the cover 3 in relation to the central mounting 2 in a plane perpendicular to the plane of rotation of the blade 1. The two half-shafts 51 can have a bevelled shape that facilitates a snap-fitting of the half-shafts 51 into a female zone of the finger 4. Each half-shaft 51 can thus have two lateral faces having different inclinations. The snap-fitting is effected using the hook-shaped ends 41 of the finger 4.

Naturally, the cowling described above can also be adapted for a whippletree blade.

1. A cowling for a windscreen wiper blade extending along a longitudinal axis, for a vehicle,
the cowling being elongate and comprising a central mounting and two end covers, at least one of the covers being provided with two longitudinal side walls that are linked by an upper longitudinal edge,
said central mounting being positioned between the two covers and assembled with each cover,
wherein said central mounting comprises lateral retaining means cooperating with the lateral retaining means of at least one of the two side walls in order to limit a lateral separation to said at least one of the two side walls.

2. The cowling according to claim 1, wherein the assembly between said at least one of the covers and the mounting is located in the space between the two side walls.

3. The cowling according to claim 1, wherein the mounting comprises lateral retaining means cooperating with the lateral retaining means of the two side walls.

4. The cowling according to claim 1, wherein the lateral retaining means of the mounting and/or of said at least one of the two side walls extend longitudinally.

5. The cowling according to claim lone of claims 1, wherein the lateral retaining means of the mounting comprise a longitudinal rib and wherein that the lateral retaining means of said at least one of the two side walls comprises a longitudinal slot formed in a projecting zone of said at least one of the two side walls.

6. The cowling according to claim 1, wherein the lateral retaining means of the mounting comprise a longitudinal slot and wherein the lateral retaining means of said at least one of the two side walls comprises a longitudinal rib projecting from said at least one of the two side walls.

7. The cowling according to claim 1, wherein the assembly between the mounting and said at least one of the covers is a fastening or a joint.

8. The cowling according to claim 1, wherein the assembly between the mounting and said at least one of the covers is a joint and in that said at least one of the covers comprises an articulation element provided with articulation means.

9. The cowling according to claim 8, wherein the joint is a pivoting link and in that the articulation means are rotation means.

10. The cowling according to claim 8, wherein the articulation means define an axis of rotation orthogonal to the longitudinal axis of the cowling.

11. The cowling according to claim 10, wherein the articulation means comprise two half-shafts arranged on either side of a central wall of said articulation element.

12. The cowling according to claim 8, wherein said at least one of the covers comprises rigid attachment means that are designed to cooperate with the rigid attachment means of the mounting to rigidly attach said at least one of the covers to said mounting.

13. The cowling according to claim 12, wherein the rigid attachment means of said at least one of the covers and the rigid attachment means of the mounting are snap-fitting means.

14. The cowling according to claim 12, wherein the rigid attachment means of said at least one of the covers are carried on the articulation element and notably on the articulation means.

15. The cowling according to claim 1, wherein the lateral retaining means of said at least one of the two side walls comprise a frangible zone.

16. A cowled flat windscreen wiper blade, comprising a cowling according to claim 1.

17. A cowled whippletree windscreen wiper blade, comprising a cowling according to claim 1.
